(19) United States
(12) Patent Application Publication
(10) Pub. No.: US 2026/0063870 A1
(43) Pub. Date: Mar. 5, 2026

(54) IMAGING LENS SYSTEM

(71) Applicant: Samsung Electro-Mechanics Co., Ltd., Suwon-si (KR)

(72) Inventors: Hyuk Joo KIM, Suwon-si (KR); Ju Hwa SON, Suwon-si (KR); Kyu Min CHAE, Suwon-si (KR); Yong Joo JO, Suwon-si (KR)

(73) Assignee: Samsung Electro-Mechanics Co., Ltd., Suwon-si (KR)

(21) Appl. No.: 19/085,529

(22) Filed: Mar. 20, 2025

(30) Foreign Application Priority Data
Sep. 5, 2024 (KR) 10-2024-0121066

(51) Int. Cl. G02B 13/00; G02B 7/02; G02B 9/64

(52) U.S. Cl. CPC G02B 13/0045; G02B 7/025; G02B 7/028; G02B 9/64; G02B 13/006

(57) ABSTRACT

An imaging lens system includes a first lens, a second lens, a third lens, a fourth lens, a fifth lens, a sixth lens, a seventh lens, and an eighth lens sequentially disposed in ascending numerical order along an optical axis of the imaging lens system from an object side of the imaging lens system toward an imaging plane of the imaging lens system, wherein the second lens has a positive refractive power, the third lens has a convex image-side surface in a paraxial region thereof, and the imaging lens system satisfies the conditional expression 0.3<f/f4<0.4, where f is a focal length of the imaging lens system, and f4 is a focal length of the fourth lens.

### CROSS-REFERENCE TO RELATED APPLICATIONS

This application claims the benefit under 35 USC 119 (a) of Korean Patent Application No. 10-2024-0121066 filed on Sep. 5, 2024, in the Korean Intellectual Property Office, the entire disclosure of which is incorporated herein by reference for all purposes.

### BACKGROUND

### 1. Field

The present disclosure relates to an imaging lens system capable of implementing constant optical performance regardless of a change in temperature of a surrounding environment.

### 2. Description of Background

A small surveillance camera may be configured to capture image information within a surveillance zone. For example, the small surveillance camera may be mounted on a front bumper, a rear bumper, or part of a vehicle, and may provide a captured image to a driver.

Early small surveillance cameras were designed to capture an image of an obstacle adjacent to a vehicle, and thus not only had a relatively low resolution, but also had a high change in resolution according to a change in temperature between −40° C. and 80° C. However, as an autonomous driving function of a vehicle is increasingly implemented, there may be demand for development of a surveillance camera having a high resolution and constant optical characteristics even under harsh temperature conditions.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an imaging lens system includes a first lens, a second lens, a third lens, a fourth lens, a fifth lens, a sixth lens, a seventh lens, and an eighth lens sequentially disposed in ascending numerical order along an optical axis of the imaging lens system from an object side of the imaging lens system toward an imaging plane of the imaging lens system, wherein the second lens has a positive refractive power, the third lens has a convex image-side surface in a paraxial region thereof, and the imaging lens system satisfies the conditional expression 0.3<f/f4<0.4, where f is a focal length of the imaging lens system, and f4 is a focal length of the fourth lens.

The first lens may have a convex object-side surface in a paraxial region thereof.

The second lens may have a concave object-side surface in a paraxial region thereof.

The fourth lens may have a convex object-side surface in a paraxial region thereof.

The fifth lens may have a convex object-side surface in a paraxial region thereof.

The sixth lens may have a convex object-side surface in a paraxial region thereof.

The sixth lens may have a concave object-side surface in a paraxial region thereof.

The seventh lens may have a convex object-side surface in a paraxial region thereof.

The eighth lens may have a convex object-side surface in a paraxial region thereof.

In another general aspect, an imaging lens system includes a first lens, a second lens, a third lens, a fourth lens, a fifth lens, a sixth lens, a seventh lens, and an eighth lens sequentially disposed in ascending numerical order along an optical axis of the imaging lens system from an object side of the imaging lens system toward an imaging plane of the imaging lens system, wherein the second lens has a positive refractive power, and the imaging lens system satisfies the conditional expression 2.0<TTL/f4<3.0, where TTL is a distance along the optical axis from an object-side surface of the first lens to the imaging plane, and f4 is a focal length of the fourth lens.

The object-side surface of the first lens may be convex in a paraxial region thereof.

The second lens may have a concave object-side surface in a paraxial region thereof.

The fourth lens may have a convex object-side surface in a paraxial region thereof.

The fifth lens may have a convex object-side surface in a paraxial region thereof.

The sixth lens may have a convex object-side surface in a paraxial region thereof.

The sixth lens may have a concave object-side surface in a paraxial region thereof.

The seventh lens may have a convex object-side surface in a paraxial region thereof.

The eighth lens may have a convex object-side surface in a paraxial region thereof.

In another general aspect, an imaging lens system includes a first lens, a second lens, a third lens, a fourth lens, a fifth lens, a sixth lens, a seventh lens, and an eighth lens sequentially disposed in ascending numerical order along an optical axis of the imaging lens system from an object side of the imaging lens system toward an imaging plane of the imaging lens system, wherein the imaging lens system satisfies the conditional expression −1.6<R3/f4<−0.4, where R3 is a radius of curvature of an object-side surface of the second lens at the optical axis, and f4 is a focal length of the fourth lens.

The second lens may have a positive refractive power.

Other features and aspects will be apparent from the following detailed description, the drawings, and the claims.

### BRIEF DESCRIPTION OF DRAWINGS

FIG. 1 is a configuration diagram of an imaging lens system according to a first embodiment of the present disclosure.

FIG. 2 illustrates aberration curves of the imaging lens system illustrated in FIG. 1.

FIG. 3 is a configuration diagram of an imaging lens system according to a second embodiment of the present disclosure.

FIG. 4 illustrates aberration curves of the imaging lens system illustrated in FIG. 3.

FIG. 5 is a configuration diagram of an imaging lens system according to a third embodiment of the present disclosure.

FIG. 6 illustrates aberration curves of the imaging lens system illustrated in FIG. 5.

FIG. 7 is a configuration diagram of an imaging lens system according to a fourth embodiment of the present disclosure.

FIG. 8 illustrates aberration curves of the imaging lens system illustrated in FIG. 7.

FIG. 9 is a configuration diagram of an imaging lens system according to a fifth embodiment of the present disclosure.

FIG. 10 illustrates aberration curves of the imaging lens system illustrated in FIG. 9.

FIG. 11 is a configuration diagram of an imaging lens system according to a sixth embodiment of the present disclosure.

FIG. 12 illustrates aberration curves of the imaging lens system illustrated in FIG. 11.

FIG. 13 is a configuration diagram of an imaging lens system according to a seventh embodiment of the present disclosure.

FIG. 14 illustrates aberration curves of the imaging lens system illustrated in FIG. 13.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the present specification, a first lens refers to a lens most adjacent to an object (or a subject), and an eighth lens refers to a lens most adjacent to an imaging plane (or an image sensor). In the present specification, a radius of curvature, a thickness of a lens or other component, a distance between lenses or other components, TTL (a distance along an optical axis from an object-side surface of the first lens to the imaging plane), IMGHT (a height of the imaging plane), and a focal length are expressed in millimeters (mm). In addition, a rate of change in a refractive index according to a change in temperature (DTn) and a coefficient of thermal expansion (CTE) described in this specification are expressed in ppm/° C., where ppm stands for parts per million.

A thickness of a lens or other component, a distance between lenses and other components, and TTL are measured along an optical axis.

Also, in a description of a shape of a lens, a statement that a surface of the lens is convex means that a paraxial region of the surface is convex, and a statement that a surface of the lens is concave means that a paraxial region of the surface is concave.

Therefore, even when it is stated that a surface of a lens is convex, an edge portion of the surface may be concave. Similarly, even when it is stated that a surface of a lens is concave, an edge portion of the surface may be convex.

A paraxial region of a lens surface is a very narrow region of the lens surface near an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

An imaging lens system according to a first aspect of the present disclosure may include a plurality of lenses. For example, the imaging lens system according to the first aspect may include a first lens, a second lens, a third lens, a fourth lens, a fifth lens, a sixth lens, a seventh lens, and an eighth lens sequentially disposed in ascending numerical order along an optical axis of the imaging lens system from an object side of the imaging lens system toward an imaging plane of the imaging lens system. The imaging lens system according to the first aspect may include a lens having a positive refractive power. For example, the imaging lens system according to the first aspect, the second lens may have a positive refractive power. The imaging lens system according to the first aspect may include a lens having a convex image-side surface. For example, in the imaging lens system according to the first aspect, the third lens may have a convex image-side surface. The imaging lens system according to the first aspect may satisfy a specific conditional expression. For example, the imaging lens system according to the first aspect may satisfy the conditional expression 0.3<f/f4<0.4, where f is a focal length of the imaging lens system, and f4 is a focal length of the fourth lens.

An imaging lens system according to a second aspect of the present disclosure may include plurality of lenses. For example, an imaging lens system according to the second aspect may include a first lens, a second lens, a third lens, a fourth lens, a fifth lens, a sixth lens, a seventh lens, and an eighth lens sequentially disposed in ascending numerical order along an optical axis of the imaging lens system from an object side of the imaging lens system toward an imaging plane of the imaging lens system. The imaging lens system according to the second aspect may include a lens having a positive refractive power. For example, in an imaging lens system according to the second aspect, the second lens may have a positive refractive power. The imaging lens system according to the second aspect may satisfy a specific conditional expression. For example, the imaging lens system according to the second aspect may satisfy the conditional expression 2.0<TTL/f4<3.0, where TTL is a distance along the optical axis from an object-side surface of the first lens to the imaging plane, and f4 is a focal length of the fourth lens.

An imaging lens system according to a third aspect of the present disclosure may include a plurality of lenses. For example, an imaging lens system according to the third aspect may include a first lens, a second lens, a third lens, a fourth lens, a fifth lens, a sixth lens, a seventh lens, and an eighth lens sequentially disposed in ascending numerical order along an optical axis of the imaging lens system from an object side of the imaging lens system toward an imaging plane of the imaging lens system. The imaging lens system according to the third aspect may include a stop. For example, the imaging lens system according to the third aspect may include a stop disposed between the fourth lens and the fifth lens. The imaging lens system according to the third aspect may include a lens made of a glass material. For example, in the imaging lens system according to the third aspect, the first lens, the second lens, the fourth lens, the sixth lens, and the seventh lens may be made of a glass material. The imaging lens system according to the third aspect may include a cemented lens.

For example, the imaging lens system according to the third aspect, the sixth and seventh lenses may be cemented to each other. To elaborate, in the imaging lens system according to the third aspect, a distance between the sixth lens and the seventh lens (a distance along the optical axis from an image-side surface of the sixth lens to an object-side surface of the seventh lens) may be smaller than approximately 0.01 mm and may be filled with an adhesive, and a radius of curvature of the image-side surface of the sixth lens and a radius of curvature of the object-side surface of the seventh lens may be approximately equal to each other.

An imaging lens system according to a fourth aspect of the present disclosure may include a plurality of lenses. For example, an imaging lens system according to the fourth aspect may include a first lens, a second lens, a third lens, a fourth lens, a fifth lens, a sixth lens, a seventh lens, and an eighth lens sequentially disposed in ascending numerical order along an optical axis of the imaging lens system from an object-side of the imaging lens system toward an imaging plane of the imaging lens system. The imaging lens system according to the fourth aspect may include a stop. For example, the imaging lens system according to the fourth aspect may include a stop disposed between the fourth lens and the fifth lens. The imaging lens system according to the fourth aspect may include a lens having specific optical characteristics. For example, in the imaging lens system according to the fourth aspect, the fourth lens may satisfy either one or both of the conditional expressions 1.0<L4DnT <4.0 and 5.0<L4CTE <9.0 (based on a wavelength of 587.6 nm). In these conditional expressions, L4DnT is a rate of change in a refractive index according to a change in temperature of the fourth lens expressed in ppm/° C., and L4CTE is a coefficient of thermal expansion of the fourth lens expressed in ppm/° C.

An imaging lens system according to a fifth aspect of the present disclosure may include a first lens, a second lens, a third lens, a fourth lens, a fifth lens, a sixth lens, a seventh lens, and an eighth lens sequentially disposed in ascending numerical order along an optical axis of the imaging lens system from an object side of the imaging lens system toward an imaging plane of the imaging lens system, and may satisfy any one or any combination of any two or more of the following conditional expressions:

$$0.3 < f / f 4 < 0.4 \qquad ( Conditional Expression 1 )$$

$$- 1. < L 4 DnT < 4. ( ppm / °C . ) \qquad ( Conditional Expression 2 )$$

$$5. < L 4 CTE < 9. ( ppm / °C . ) \qquad ( Conditional Expression 3 )$$

$$1.65 < Nd 4 < 1.9 \qquad ( Conditional Expression 4 )$$

In the above conditional expressions, f is a focal length of the imaging lens system, f4 is a focal length of the fourth lens, L4DnT is a rate of change in a refractive index according to a change in temperature of the fourth lens, L4CTE is a coefficient of thermal expansion of the fourth lens, and Nd4 is a refractive index of the fourth lens.

An imaging lens system according to a sixth aspect of the present disclosure may include a first lens, a second lens, a third lens, a fourth lens, a fifth lens, a sixth lens, a seventh lens, and an eighth lens sequentially disposed in ascending numerical order along an optical axis of the imaging lens system from an object side of the imaging lens system toward an imaging plane of the imaging lens system, and may satisfy any one or any combination of any two or more of the following conditional expressions:

$$- 1. < f 1 / f 4 < - 0.2 \qquad ( Conditional Expression 5 )$$

$$1.2 < f 2 / f 4 < 3.2 \qquad ( Conditional Expression 6 )$$

$$- 8. < f 3 / f 4 < - 1. \qquad ( Conditional Expression 7 )$$

$$0.8 < f 5 / f 4 < 1.8 \qquad ( Conditional Expression 8 )$$

$$- 1. < f 6 / f 4 < - 0.2 \qquad ( Conditional Expression 9 )$$

$$0.2 < f 7 / f 4 < 1.2 \qquad ( Conditional Expression 10 )$$

$$1. < f 8 / f 4 < 90 \qquad ( Conditional Expression 11 )$$

$$2. < TTL / f 4 < 3. \qquad ( Conditional Expression 12 )$$

$$1.2 < R 1 / f 4 < 2.4 \qquad ( Conditional Expression 13 )$$

$$- 1.6 < R 3 / f 4 < - 0.4 \qquad ( Conditional Expression 14 )$$

In the above conditional expressions, f1 is a focal length of the first lens, f2 is a focal length of the second lens, f3 is a focal length of the third lens, f4 is a focal length of the fourth lens, f5 is a focal length of the fifth lens, f6 is a focal length of the sixth lens, f7 is a focal length of the seventh lens, f8 is a focal length of the eighth lens, TTL is a distance along the optical axis from an object-side surface of the first lens to the imaging plane, R1 is a radius of curvature of the object-side surface of the first lens at the optical axis, and R3 is a radius of curvature of an object-side surface of the second lens at the optical axis.

An imaging lens system according to a seventh aspect of the present disclosure may include a first lens, a second lens, a third lens, a fourth lens, a fifth lens, a sixth lens, a seventh lens, and an eighth lens sequentially disposed in ascending numerical order along an optical axis of the imaging lens system from an object side of the imaging lens system toward an imaging plane of the imaging lens system, and may satisfy any one or any combination of any two or more of the following conditional expressions:

$$- 2. < f 6 / f < - 1.2 \qquad ( Conditional Expression 15 )$$

$$1. < f 7 / f < 2.6 \qquad ( Conditional Expression 16 )$$

$$- 1.2 < f 6 / f 7 < - 0.6 \qquad ( Conditional Expression 17 )$$

$$- 1.6 < ( R 1 + R 3 ) / R 4 < - 0.6 \qquad ( Conditional Expression 18 )$$

$$0.8 < ( R 5 + R 6 ) / R 3 < 1.4 \qquad ( Conditional Expression 19 )$$

$$- 1.4 < ( R 4 + R 5 ) / R 7 < - 0.8 \qquad ( Conditional Expression 20 )$$

In the above conditional expressions, R4 is a radius of curvature of an image-side surface of the second lens at the optical axis, R5 is a radius of curvature of an object-side surface of the third lens at the optical axis, R6 is a radius of curvature of an image-side surface of the third lens at the optical axis, and R7 is a radius of curvature of an object-side surface of the fourth lens at the optical axis.

An imaging lens system according to an eighth aspect of the present disclosure may include any combination of any two or more of the first to seventh aspects according to the following characteristics. For example, the imaging lens system according to the eighth aspect may include the characteristics of the first aspect, and may satisfy any one or any combination of any two or more of the conditional expressions according to the fifth aspect. As another example, the imaging lens system according to the eighth aspect may include the characteristics of the second aspect, and may satisfy any one or any combination of any two or more of the conditional expressions according to the sixth aspect or the seventh aspect.

The imaging lens system according to the first to eighth aspects may include any one or any combination of any two or more of the first to eighth lenses having the characteristics described below. As an example, the imaging lens system according to the first aspect may include one of the first to eighth lenses having the characteristics described below. As another example, the imaging lens system according to the second aspect may include any combination of any two or more of the first to eighth lenses having the characteristics described below. However, the imaging lens system according to the above-described aspects does not necessarily include a lens having the characteristics described below. Characteristics of the first to eighth lenses are described below.

The first lens may have a refractive power. For example, the first lens may have a negative refractive power. The first lens may have a convex shape on one surface. For example, the first lens may have a convex object-side surface. The first lens may include a spherical surface or an aspherical surface. For example, both surfaces of the first lens may be spherical. The first lens may be made of a material having a high light transmittance and an excellent processability. For example, the first lens may be made of a glass material. The first lens may have characteristics advantageous for improving aberration. For example, the first lens may have a refractive index of 1.78 or more and an Abbe number of 40 or more.

The second lens may have a refractive power. For example, the second lens may have a positive refractive power. The second lens may have a concave shape on one surface. For example, the second lens may have a concave object-side surface. The second lens may include a spherical surface. For example, both surfaces of the second lens may be spherical. The second lens may be made of a material having a high light transmittance and an excellent processability. For example, the second lens may be made of a glass material. The second lens may have a predetermined refractive index. For example, a refractive index of the second lens may be 1.80 or more. The second lens may have a predetermined Abbe number. For example, an Abbe number of the second lens may be greater than 30 and less than 50.

The third lens may have a refractive power. For example, the third lens may have a negative refractive power. The third lens may have a convex shape on one surface. For example, the third lens may have a convex image-side surface. The third lens may include an aspherical surface. For example, both surfaces of the third lens may be aspherical. The third lens may be made of a different material than the second lens. For example, the third lens may be made of a plastic material. The third lens may have a predetermined refractive index. For example, the third lens may have a refractive index of 1.50 or more. The third lens may have a predetermined Abbe number. For example, an Abbe number of the third lens may be greater than 52.

The fourth lens may have a refractive power. For example, the fourth lens may have a positive refractive power. The fourth lens may have a convex shape on one surface. For example, the fourth lens may have a convex object-side surface. The fourth lens may include a spherical surface. For example, both surfaces of the fourth lens may be spherical. The fourth lens may be made of a different material than the third lens. For example, the fourth lens may be made of a glass material. The fourth lens may have a predetermined refractive index. For example, a refractive index of the fourth lens may be 1.7 or more. The fourth lens may have a predetermined Abbe number. For example, an Abbe number of the fourth lens may be greater than 46.

The fifth lens may have a refractive power. For example, the fifth lens may have a positive refractive power. The fifth lens may have a convex shape on one surface. For example, the fifth lens may have a convex object-side surface. The fifth lens may include an aspherical surface. For example, both surfaces of the fifth lens may be aspherical. The fifth lens may be made of a different material than the fourth lens. For example, the fifth lens may be made of a plastic material. The fifth lens may have a predetermined refractive index. For example, a refractive index of the fifth lens may be less than 1.6. The fifth lens may have a predetermined Abbe number. For example, an Abbe number of the fifth lens may be greater than 52.

The sixth lens may have a refractive power. For example, the sixth lens may have a negative refractive power. The sixth lens may have a convex shape on one surface. For example, the sixth lens may have a convex object-side surface. Alternatively, the sixth lens may have a concave object-side surface and a concave image-side surface. The sixth lens may include a spherical or an aspherical surface. For example, both surfaces of the sixth lens may be spherical or one surface may be aspherical. The sixth lens may be made of a different material than the fifth lens. For example, the sixth lens may be made of a glass material. The sixth lens may have a predetermined refractive index. For example, a refractive index of the sixth lens may be greater than 1.6. The sixth lens may have a predetermined Abbe number. For example, an Abbe number of the sixth lens may be less than 30.

The seventh lens may have a refractive power. For example, the seventh lens may have a positive refractive power. The seventh lens may have a convex shape on one surface. For example, the seventh lens may have a convex object-side surface. The seventh lens may include a spherical or an aspherical surface. For example, both surfaces of the seventh lens may be spherical or an image-side surface may be aspherical. The seventh lens may be made of the same material as the sixth lens. For example, the seventh lens may be made of a glass material. The seventh lens may have a predetermined refractive index. For example, the refractive index of the seventh lens may be 1.5 or greater. The seventh lens may have a predetermined Abbe number. For example, an Abbe number of the seventh lens may be greater than 60. Alternatively, the Abbe number of the seventh lens may be greater than 52. The seventh lens may be cemented to the sixth lens. For example, a radius of curvature of an object-side surface of the seventh lens may be substantially equal to a radius of curvature of an image-side surface of the sixth lens.

The eighth lens may have a refractive power. For example, the eighth lens may have a positive refractive power. The eighth lens may have a convex shape on one surface. For example, the eighth lens may have a convex object-side surface. The eighth lens may include an aspherical surface. For example, both surfaces of the eighth lens may be aspherical. Alternatively, both surfaces of the eighth lens may be spherical. The eighth lens may be made of a different material than the seventh lens. For example, the eighth lens may be made of a plastic material. The eighth lens may have a predetermined refractive index. For example, a refractive index of the eighth lens may be 1.50 or more. The eighth lens may have a predetermined Abbe number. For example, an Abbe number of the eighth lens may be 52 or more.

An aspherical surface of a lens is defined by the following Equation 1:

$$Z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + {Hr}^{18} \qquad ( 1 )$$

In Equation 1, c is a curvature of the lens surface and is equal to a reciprocal of a radius of curvature of the lens surface at an optical axis of the lens surface, k is a conic constant, and r is a distance from any point on the aspherical surface of the lens to the optical axis. In addition, constants A to H are aspherical surface coefficients. Z (also known as sag) is a distance in a direction parallel to an optical axis direction between the point on the aspherical surface of the lens at the distance r from the optical axis of the aspherical surface to a tangential plane perpendicular to the optical axis and intersecting a vertex of the aspherical surface.

An imaging lens system may include lenses made of different materials. For example, the first lens, second lens, fourth lens, sixth lens, and seventh lens may be made of a different material than the third lens, fifth lens, and eighth lens. As a specific example, the first lens, second lens, fourth lens, sixth lens, and seventh lens are made of a glass material that has a low coefficient of thermal expansion due to external shock and a change in temperature, and the third lens, fifth lens, and eighth lens are made of a plastic material that is easy to process. However, the materials of the first to eighth lenses are not limited to the examples described above. For example, it may be possible to change the second lens to a plastic material and the third lens to a glass material.

The imaging lens system may include a stop, an imaging plane, and a filter.

The stop may be disposed between two of the lenses. For example, the stop may be disposed between the fourth lens and the fifth lens. As another example, the stop may be disposed on an object side of a lens made of a glass material and having a positive refractive power. The imaging plane may be formed at a point at which light refracted by the first to eighth lenses forms an image. The imaging plane may be formed by an image sensor. For example, the imaging plane may be formed on a surface of the image sensor or on an internal layer of the image sensor. The filter may be disposed between the eighth lens and the imaging plane. The filter may block certain wavelengths of light. For example, the filter may block light in infrared wavelengths.

Hereinafter, embodiments of the present disclosure will be described in detail with reference to the drawings.

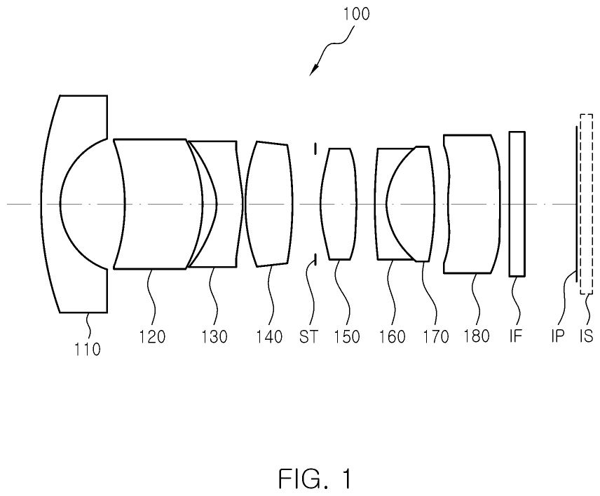

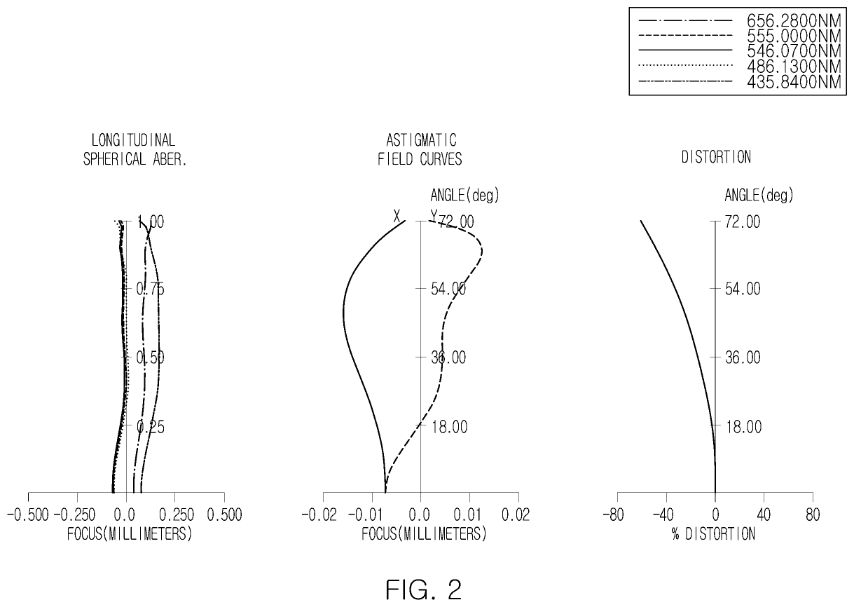

FIG. 1 is a configuration diagram of an imaging lens system according to a first embodiment of the present disclosure. FIG. 2 illustrates aberration curves of the imaging lens system illustrated in FIG. 1.

Referring to FIG. 1, an imaging lens system 100 may include a first lens 110, a second lens 120, a third lens 130, a fourth lens 140, a fifth lens 150, a sixth lens 160, a seventh lens 170, and an eighth lens 180.

The first lens 110 may have a negative refractive power, and may have a convex object-side surface and a concave image-side surface. The second lens 120 may have a positive refractive power, and may have a concave object-side surface and a convex image-side surface. The third lens 130 may have a negative refractive power, and may have a concave object-side surface and a convex image-side surface. The fourth lens 140 may have a positive refractive power, and may have a convex object-side surface and a convex image-side surface. The fifth lens 150 may have a positive refractive power, and may have a convex object-side surface and a convex image-side surface. The sixth lens 160 may have a negative refractive power, and may have a convex object-side surface and a concave image-side surface. The seventh lens 170 may have a positive refractive power, and may have a convex object-side surface and a convex image-side surface. The eighth lens 180 may have a positive refractive power, and may have a convex object-side surface and a concave image-side surface.

The imaging lens system 100 may further include a stop ST, a filter IF, and an imaging plane IP. The stop ST may be disposed between the fourth lens 140 and the fifth lens 150. The imaging plane IP may be formed on an image sensor IS, and the filter IF may be disposed between the eighth lens 180 and the imaging plane IP.

Tables 1 and 2 below illustrate lens characteristics and aspherical values of the imaging lens system 100.

TABLE 1

| | | | | | Refrac- | |
|---|---|---|---|---|---|---|
| Surface | Compo- | Radius of | Thickness/ | Effective | tive | Abbe |
| No. | nent | Curvature | Distance | Radius | Index | No. |
| S1 | 1st Lens | 21.5080 | 1.2317 | 6.825 | 1.835 | 42.7 |
| S2 | | 4.3281 | 3.7091 | 4.026 | | |
| S3 | 2nd Lens | −12.8821 | 4.5000 | 3.900 | 1.953 | 32.3 |
| S4 | | −8.7264 | 0.7835 | 4.038 | | |
| S5 | 3rd Lens | −3.8639 | 1.5351 | 3.925 | 1.535 | 56.0 |
| S6 | | −8.9516 | 0.2000 | 3.900 | | |
| S7 | 4th Lens | 11.6796 | 2.6711 | 3.921 | 1.729 | 54.6 |
| S8 | | −21.0803 | 1.2607 | 3.708 | | |
| S9 | Stop | Infinity | 0.4685 | 3.109 | | |
| S10 | 5th Lens | 9.2242 | 1.7142 | 3.271 | 1.535 | 56.0 |
| S11 | | −27.8123 | 0.9254 | 3.363 | | |
| S12 | 6th Lens | 31.2844 | 0.7000 | 3.364 | 1.846 | 23.7 |
| S13 | 7th Lens | 4.4625 | 3.6125 | 3.300 | 1.592 | 68.6 |
| S14 | | −22.1163 | 0.4470 | 3.621 | | |
| S15 | 8th Lens | 39.6293 | 2.1757 | 3.698 | 1.535 | 56.0 |
| S16 | | 1420.1319 | 0.5334 | 4.204 | | |
| S17 | Filter | Infinity | 0.9000 | 4.338 | 1.516 | 64.1 |
| S18 | | Infinity | 2.6321 | 4.422 | | |
| S19 | Imaging | Infinity | 0.0000 | 4.810 | | |
| | Plane | | | | | |

TABLE 2

| Surface No. | S5 | S6 | S10 | S11 | S15 | S16 |
|---|---|---|---|---|---|---|
| k | −2.401E+00 | 3.900E+00 | −1.568E+00 | −3.793E+01 | 9.615E+01 | −9.900E+01 |
| A | −2.800E−03 | −1.323E+01 | −7.163E−02 | −1.269E−01 | −5.387E−01 | −5.918E−01 |
| B | −1.383E−03 | 2.005E−01 | −1.801E−02 | −2.008E−02 | −2.544E−02 | 1.478E−03 |
| C | −2.058E−04 | −5.531E−04 | −2.843E−03 | −2.860E−03 | 8.325E−04 | 6.602E−03 |
| D | 3.484E−04 | −1.890E−03 | −4.355E−04 | −4.169E−04 | 7.381E−04 | 9.159E−04 |
| E | −3.877E−05 | 5.296E−04 | −9.829E−05 | −6.495E−05 | 1.825E−04 | 3.139E−04 |
| F | 5.626E−06 | −5.992E−05 | 9.546E−06 | −1.325E−05 | 0 | 0 |
| G | 6.606E−06 | 4.019E−06 | −2.890E−06 | −1.343E−05 | 0 | 0 |
| H | 0 | 2.530E−05 | 0 | 0 | 0 | 0 |

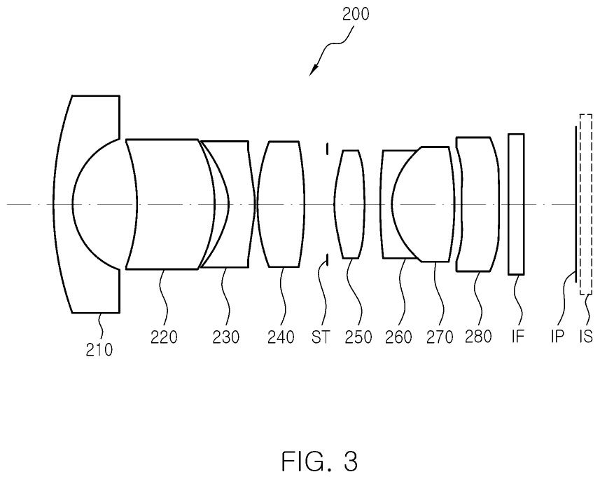

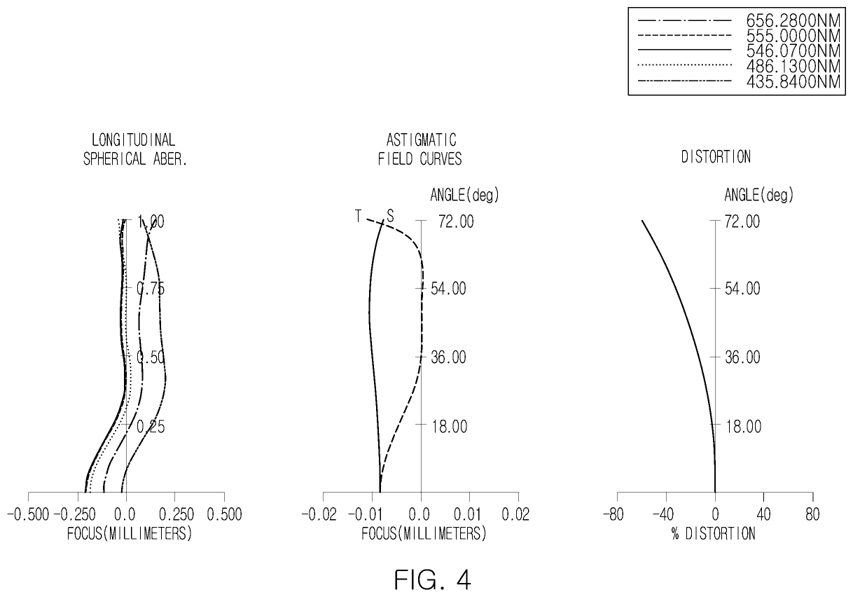

FIG. 3 is a configuration diagram of an imaging lens system according to a second embodiment of the present disclosure. FIG. 4 illustrates aberration curves of the imaging lens system illustrated in FIG. 3.

Referring to FIG. 3, an imaging lens system 200 may include a first lens 210, a second lens 220, a third lens 230, a fourth lens 240, a fifth lens 250, a sixth lens 260, a seventh lens 270, and an eighth lens 280.

The first lens 210 may have a negative refractive power, and may have a convex object-side surface and a concave image-side surface. The second lens 220 may have a positive refractive power, and may have a concave object-side surface and a convex image-side surface. The third lens 230 may have a negative refractive power, and may have a concave object-side surface and a convex image-side surface. The fourth lens 240 may have a positive refractive power, and may have a convex object-side surface and a convex image-side surface. The fifth lens 250 may have a positive refractive power, and may have a convex object-side surface and a convex image-side surface. The sixth lens 260 may have a negative refractive power, and may have a convex object-side surface and a concave image-side surface. The seventh lens 270 may have a positive refractive power, and may have a convex object-side surface and a convex image-side surface. The eighth lens 280 may have a positive refractive power, and may have a convex object-side surface and a concave image-side surface.

The imaging lens system 200 may further include a stop ST, a filter IF, and an imaging plane IP. The stop ST may be disposed between the fourth lens 240 and the fifth lens 250. The imaging plane IP may be formed on an image sensor IS, and the filter IF may be disposed between the eighth lens 280 and the imaging plane IP.

Tables 3 and 4 below illustrate lens characteristics and aspherical values of the imaging lens system 200.

TABLE 3

| Sur- | | | | | Refrac- | |
|---|---|---|---|---|---|---|
| face | | Radius of | Thickness/ | Effective | tive | Abbe |
| No. | Component | Curvature | Distance | Radius | Index | No. |
| S1 | 1st Lens | 21.6042 | 1.1063 | 6.825 | 1.835 | 42.7 |
| S2 | | 4.4113 | 3.6768 | 4.026 | | |
| S3 | 2nd Lens | −13.2901 | 4.5000 | 3.900 | 1.903 | 31.3 |
| S4 | | −8.7918 | 0.7623 | 4.038 | | |
| S5 | 3rd Lens | −3.7386 | 1.5001 | 3.925 | 1.535 | 56.0 |
| S6 | | −9.1870 | 0.2000 | 3.900 | | |
| S7 | 4th Lens | 11.9701 | 2.6695 | 3.921 | 1.729 | 54.6 |
| S8 | | −22.3465 | 1.3070 | 3.708 | | |
| S9 | Stop | Infinity | 0.3000 | 3.109 | | |
| S10 | 5th Lens | 8.9556 | 2.0589 | 3.271 | 1.535 | 56.0 |
| S11 | | −26.7088 | 1.0403 | 3.363 | | |
| S12 | 6th Lens | 30.0435 | 0.7002 | 3.364 | 1.846 | 23.7 |
| S13 | 7th Lens | 4.5426 | 2.7367 | 3.300 | 1.592 | 68.6 |
| S14 | | −19.7052 | 0.7968 | 3.621 | | |
| S15 | 8th Lens | 39.9672 | 2.9447 | 3.698 | 1.535 | 56.0 |
| S16 | | 188.0762 | 0.5334 | 4.204 | | |
| S17 | Filter | Infinity | 0.9000 | 4.232 | 1.516 | 64.1 |
| S18 | | Infinity | 2.2671 | 4.303 | | |
| S19 | Imaging | Infinity | 0.0000 | 4.627 | | |
| | Plane | | | | | |

TABLE 4

| | Surface No. | | | | | |
|---|---|---|---|---|---|---|
| | S5 | S6 | S10 | S11 | S15 | S16 |
| k | −2.393E+00 | −1.600E+01 | −1.904E+00 | −2.696E+01 | 9.900E+01 | −9.900E+01 |
| A | 8.639E−03 | 1.979E−01 | −8.370E−02 | −1.549E−01 | −4.871E−01 | −5.833E−01 |
| B | −2.897E−03 | 8.310E−04 | −1.447E−02 | −1.635E−02 | −1.907E−02 | 1.170E−02 |
| C | −5.604E−05 | −2.335E−03 | −1.780E−03 | −1.840E−03 | 6.698E−04 | 6.475E−03 |
| D | 2.547E−04 | 6.823E−04 | −2.680E−04 | −2.326E−04 | 5.957E−04 | 8.096E−04 |
| E | −3.889E−05 | −1.405E−04 | −1.609E−05 | 0 | 1.062E−04 | 2.876E−04 |
| F | 0 | 3.020E−05 | 1.099E−05 | 0 | 0 | 0 |
| G | 0 | −6.399E−07 | 1.081E−05 | 0 | 0 | 0 |

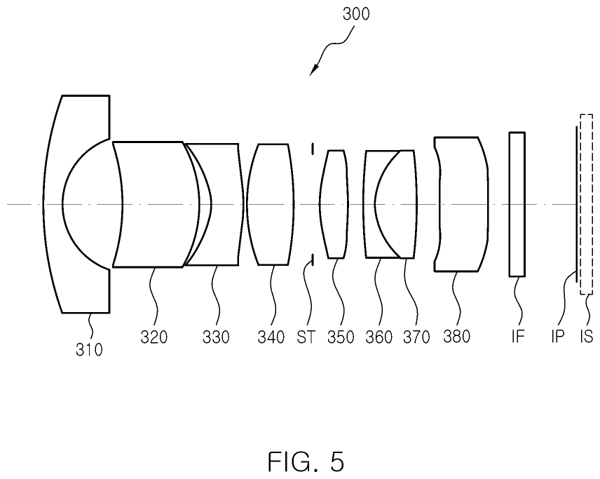

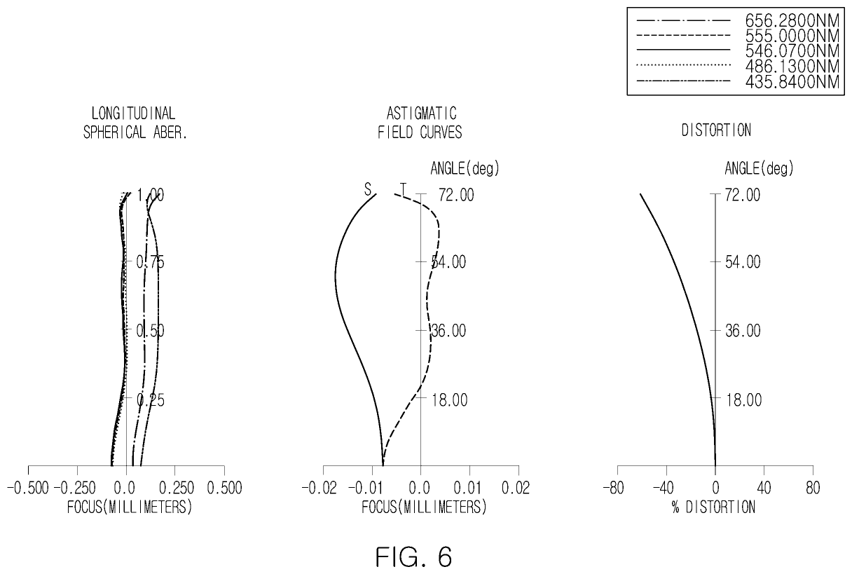

FIG. 5 is a configuration diagram of an imaging lens system according to a third embodiment of the present disclosure. FIG. 6 illustrates aberration curves of the imaging lens system illustrated in FIG. 5.

Referring to FIG. 5, an imaging lens system 300 may include a first lens 310, a second lens 320, a third lens 330, a fourth lens 340, a fifth lens 350, a sixth lens 360, a seventh lens 370, and an eighth lens 380.

The first lens 310 may have a negative refractive power, and may have a convex object-side surface and a concave image-side surface. The second lens 320 may have a positive refractive power, and may have a concave object-side surface and a convex image-side surface. The third lens 330 may have a negative refractive power, and may have a concave object-side surface and a convex image-side surface. The fourth lens 340 may have a positive refractive power, and may have a convex object-side surface and a convex image-side surface. The fifth lens 350 may have a positive refractive power, and may have a convex object-side surface and a convex image-side surface. The sixth lens 360 may have a negative refractive power, and may have a convex object-side surface and a concave image-side surface. The seventh lens 370 may have a positive refractive power, and may have a convex object-side surface and a convex image-side surface. The eighth lens 380 may have a positive refractive power, and may have a convex object-side surface and a convex image-side surface.

The imaging lens system 300 may further include a stop ST, a filter IF, and an imaging plane IP. The stop ST may be disposed between the fourth lens 340 and the fifth lens 350. The imaging plane IP may be formed on an image sensor IS, and the filter IF may be disposed between the eighth lens 380 and the imaging plane IP.

Tables 5 and 6 below illustrate lens characteristics and aspherical values of the imaging lens system 300.

TABLE 5

| Sur- | | | | | Refrac- | |
|---|---|---|---|---|---|---|
| face | | Radius of | Thickness/ | Effective | tive | Abbe |
| No. | Component | Curvature | Distance | Radius | Index | No. |
| S1 | 1st Lens | 22.2608 | 1.2629 | 6.921 | 1.804 | 46.5 |
| S2 | | 4.3504 | 3.5156 | 4.047 | | |
| S3 | 2nd Lens | −14.3554 | 4.5000 | 3.967 | 1.953 | 32.3 |
| S4 | | −8.9925 | 0.7238 | 3.942 | | |
| S5 | 3rd Lens | −3.9934 | 1.8955 | 3.858 | 1.535 | 56.0 |
| S6 | | −11.3504 | 0.2000 | 3.815 | | |
| S7 | 4th Lens | 11.6461 | 2.7278 | 3.866 | 1.729 | 54.6 |
| S8 | | −21.4405 | 1.2304 | 3.665 | | |
| S9 | Stop | Infinity | 0.3000 | 3.160 | | |
| S10 | 5th Lens | 8.8086 | 1.7058 | 3.314 | 1.535 | 56.0 |
| S11 | | −38.0027 | 0.8580 | 3.388 | | |
| S12 | 6th Lens | 22.2988 | 0.7000 | 3.383 | 1.846 | 23.7 |
| S13 | 7th Lens | 4.5621 | 2.4743 | 3.297 | 1.592 | 68.6 |
| S14 | | −32.7046 | 1.3673 | 3.423 | | |
| S15 | 8th Lens | 39.0468 | 2.8386 | 3.628 | 1.535 | 56.0 |
| S16 | | −177.6494 | 1.2169 | 4.291 | | |
| S17 | Filter | Infinity | 0.9000 | 4.501 | 1.516 | 64.1 |
| S18 | | Infinity | 1.5831 | 4.577 | | |
| S19 | Imaging | Infinity | 0.0000 | 4.797 | | |
| | Plane | | | | | |

TABLE 6

| | Surface No. | | | | | |
|---|---|---|---|---|---|---|
| | S5 | S6 | S10 | S11 | S15 | S16 |
| k | −2.212E+00 | −1.995E+01 | −2.176E+00 | 9.858E+01 | 9.900E+01 | 3.451E+00 |
| A | 3.008E−02 | 2.020E−01 | −5.356E−02 | −6.523E−02 | −5.229E−01 | −6.110E−01 |
| B | −4.039E−03 | −5.851E−04 | −1.887E−02 | −1.443E−02 | −3.051E−02 | 1.787E−03 |
| C | 1.811E−04 | −1.630E−03 | −3.077E−03 | −1.839E−03 | −1.558E−03 | 6.103E−03 |
| D | 1.861E−04 | 3.827E−04 | −5.813E−04 | −1.932E−04 | 1.685E−04 | 7.532E−04 |
| E | −1.328E−05 | −6.055E−05 | −1.202E−04 | 0 | 5.991E−05 | 2.880E−04 |
| F | 0 | 8.122E−06 | −2.140E−05 | 0 | 0 | 0 |
| G | 0 | 4.255E−06 | 0 | 0 | 0 | 0 |

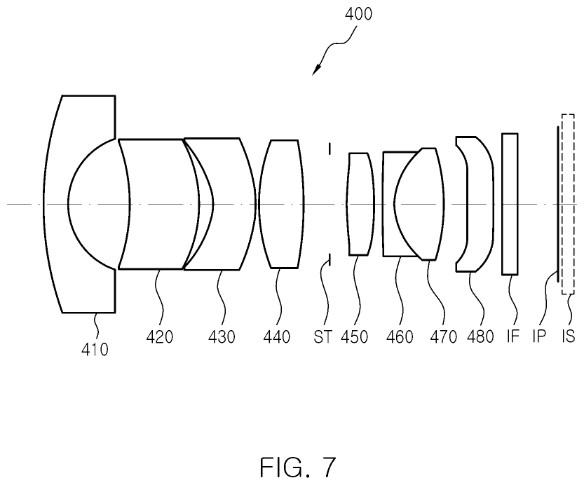

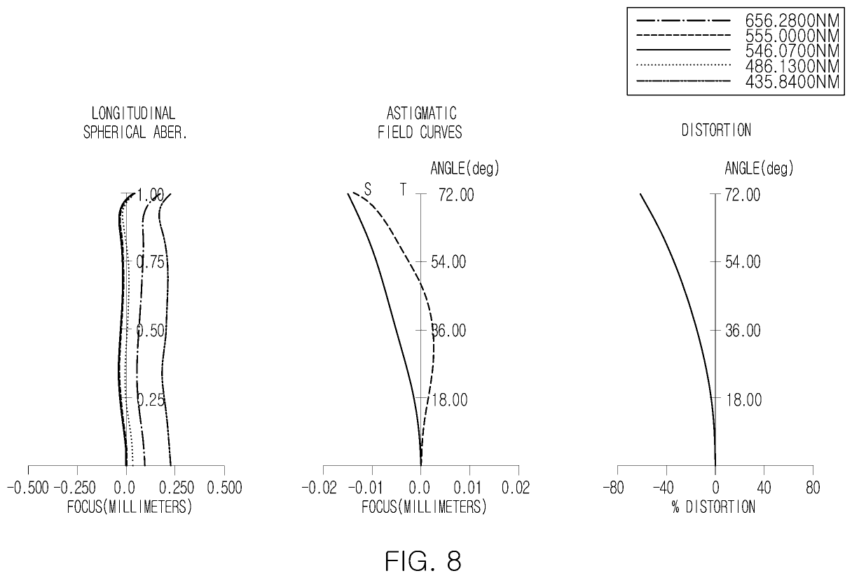

FIG. 7 is a configuration diagram of an imaging lens system according to a fourth embodiment of the present disclosure. FIG. 8 illustrates aberration curves of the imaging lens system illustrated in FIG. 7.

Referring to FIG. 7, an imaging lens system 400 may include a first lens 410, a second lens 420, a third lens 430, a fourth lens 440, a fifth lens 450, a sixth lens 460, a seventh lens 470, and an eighth lens 480.

The first lens 410 may have a negative refractive power, and may have a convex object-side surface and a concave image-side surface. The second lens 420 may have a positive refractive power, and may have a concave object-side surface and a convex image-side surface. The third lens 430 may have a negative refractive power, and may have a concave object-side surface and a convex image-side surface. The fourth lens 440 may have a positive refractive power, and may have a convex object-side surface and a convex image-side surface. The fifth lens 450 may have a positive refractive power, and may have a convex object-side surface and a convex image-side surface. The sixth lens 460 may have a negative refractive power, and may have a convex object-side surface and a concave image-side surface. The seventh lens 470 may have a positive refractive power, and may have a convex object-side surface and a convex image-side surface. The eighth lens 480 may have a positive refractive power, and may have a convex object-side surface and a concave image-side surface.

The imaging lens system 400 may further include a stop ST, a filter IF, and an imaging plane IP. The stop ST may be disposed between the fourth lens 440 and the fifth lens 450. The imaging plane IP may be formed on an image sensor IS, and the filter IF may be disposed between the eighth lens 480 and the imaging plane IP.

Tables 7 and 8 below illustrate lens characteristics and aspherical values of the imaging lens system 400.

TABLE 7

| Sur- | | | | | Refrac- | |
|---|---|---|---|---|---|---|
| face | | Radius of | Thickness/ | Effective | tive | Abbe |
| No. | Component | Curvature | Distance | Radius | Index | No. |
| S1 | 1st Lens | 23.2762 | 1.5233 | 6.902 | 1.880 | 40.8 |
| S2 | | 4.4337 | 3.4947 | 4.041 | | |
| S3 | 2nd Lens | −12.2714 | 4.0804 | 3.969 | 1.830 | 42.7 |
| S4 | | −8.4440 | 0.7847 | 4.082 | | |
| S5 | 3rd Lens | −4.4574 | 2.4824 | 4.010 | 1.535 | 56.0 |
| S6 | | −7.4861 | 0.1958 | 4.176 | | |
| S7 | 4th Lens | 11.8313 | 2.5902 | 4.059 | 1.770 | 49.6 |
| S8 | | −24.5959 | 1.4933 | 3.802 | | |
| S9 | Stop | Infinity | 1.0228 | 2.998 | | |
| S10 | 5th Lens | 17.4991 | 1.6045 | 3.113 | 1.535 | 56.0 |
| S11 | | −18.8136 | 0.4940 | 3.243 | | |
| S12 | 6th Lens | 100.4997 | 0.7000 | 3.259 | 1.846 | 23.7 |
| S13 | 7th Lens | 4.7120 | 2.8819 | 3.298 | 1.592 | 68.6 |
| S14 | | −13.0938 | 1.3704 | 3.528 | | |
| S15 | 8th Lens | 58.4040 | 1.5087 | 3.750 | 1.535 | 56.0 |
| S16 | | 126.5892 | 0.5000 | 4.260 | | |
| S17 | Filter | Infinity | 0.9000 | 4.427 | 1.516 | 64.1 |
| S18 | | Infinity | 2.3731 | 4.498 | | |
| S19 | Imaging | Infinity | 0.0000 | 4.789 | | |
| | Plane | | | | | |

TABLE 8

| | Surface No. | | | | | |
|---|---|---|---|---|---|---|
| | S5 | S6 | S10 | S11 | S15 | S16 |
| k | −2.348E+00 | −5.117E+00 | 1.444E+01 | −2.209E−01 | 9.900E+01 | 9.900E+01 |
| A | −2.418E−01 | −5.708E−02 | −1.423E−01 | −1.094E−01 | −7.037E−01 | −1.025E+00 |
| B | 3.047E−02 | 2.198E−02 | −1.892E−02 | −2.030E−02 | −7.161E−02 | −6.743E−02 |
| C | −3.180E−03 | −2.711E−03 | −2.162E−03 | −1.860E−03 | −1.050E−02 | −5.267E−03 |
| D | 4.264E−04 | 3.232E−04 | −3.320E−04 | −2.032E−04 | −2.046E−03 | −1.929E−03 |
| E | −4.226E−05 | −5.336E−05 | −2.167E−05 | 0 | −2.751E−04 | −2.338E−04 |
| F | 0 | 5.324E−06 | 3.521E−06 | 0 | 0 | 0 |
| G | 0 | −2.385E−06 | 1.162E−05 | 0 | 0 | 0 |

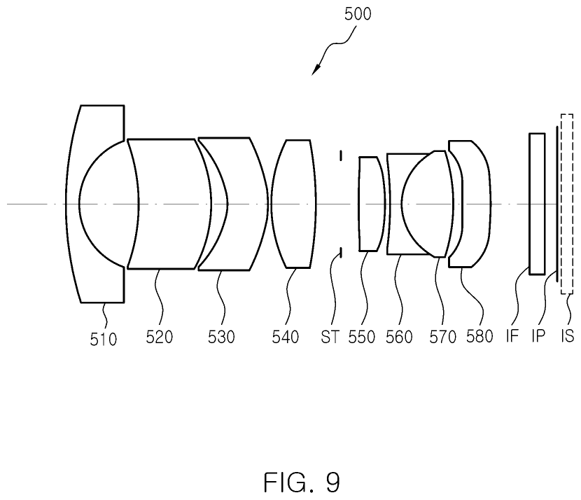

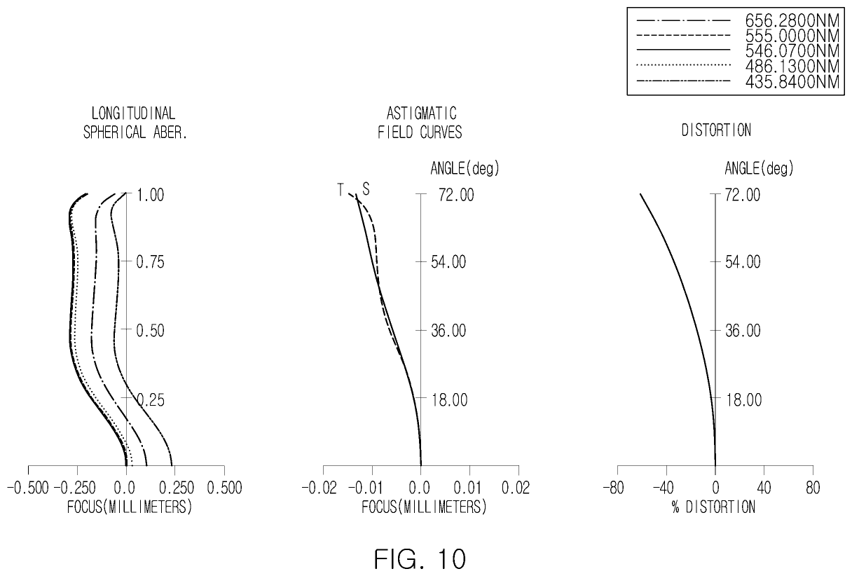

FIG. 9 is a configuration diagram of an imaging lens system according to a fifth embodiment of the present disclosure. FIG. 10 illustrates aberration curves of the imaging lens system illustrated in FIG. 9.

Referring to FIG. 9, an imaging lens system 500 may include a first lens 510, a second lens 520, a third lens 530, a fourth lens 540, a fifth lens 550, a sixth lens 560, a seventh lens 570, and an eighth lens 580.

The first lens 510 may have a negative refractive power, and may have a convex object-side surface and a concave image-side surface. The second lens 520 may have a positive refractive power, and may have a concave object-side surface and a convex image-side surface. The third lens 530 may have a negative refractive power, and may have a concave object-side surface and a convex image-side surface. The fourth lens 540 may have a positive refractive power, and may have a convex object-side surface and a convex image-side surface. The fifth lens 550 may have a positive refractive power, and may have a convex object-side surface and a convex image-side surface. The sixth lens 560 may have a negative refractive power, and may have a concave object-side surface and a concave image-side surface. The seventh lens 570 may have a positive refractive power, and may have a convex object-side surface and a convex image-side surface. The eighth lens 580 may have a positive refractive power, and may have a concave object-side surface and a convex image-side surface.

The imaging lens system 500 may further include a stop ST, a filter IF, and an imaging plane IP. The stop ST may be disposed between the fourth lens 540 and the fifth lens 550. The imaging plane IP may be formed on an image sensor IS, and the filter IF may be disposed between the eighth lens 580 and the imaging plane IP.

Tables 9 and 10 below illustrate lens characteristics and aspherical values of the imaging lens system 500.

TABLE 9

| Sur- | | | | | Refrac- | |
|---|---|---|---|---|---|---|
| face | | Radius of | Thickness/ | Effective | tive | Abbe |
| No. | Component | Curvature | Distance | Radius | Index | No. |
| S1 | 1st Lens | 24.0707 | 0.8346 | 6.529 | 1.880 | 40.8 |
| S2 | | 4.6003 | 3.5970 | 4.183 | | |
| S3 | 2nd Lens | −12.8437 | 4.5000 | 4.121 | 1.830 | 42.7 |
| S4 | | −8.9612 | 0.9357 | 4.309 | | |
| S5 | 3rd Lens | −4.8825 | 2.5000 | 4.186 | 1.536 | 56.0 |
| S6 | | −7.3014 | 0.2000 | 4.394 | | |
| S7 | 4th Lens | 10.4026 | 2.6867 | 4.166 | 1.720 | 54.6 |
| S8 | | −26.9120 | 1.5433 | 3.841 | | |
| S9 | Stop | Infinity | 1.1021 | 2.914 | | |
| S10 | 5th Lens | 29.6014 | 1.6192 | 2.980 | 1.535 | 56.0 |
| S11 | | −12.7028 | 0.3000 | 3.116 | | |
| S12 | 6th Lens | −23.4964 | 0.7000 | 3.122 | 1.680 | 26.8 |
| S13 | 7th Lens | 4.0682 | 3.1457 | 3.336 | 1.592 | 68.6 |
| S14 | | −12.3632 | 0.5591 | 3.517 | | |
| S15 | 8th Lens | −48.2949 | 1.7084 | 3.554 | 1.536 | 56.0 |
| S16 | | −44.6035 | 2.3853 | 4.168 | | |
| S17 | Filter | Infinity | 0.9000 | 4.595 | 1.516 | 64.1 |
| S18 | | Infinity | 0.8062 | 4.669 | | |
| S19 | Imaging | Infinity | −0.0257 | 4.780 | | |
| | Plane | | | | | |

TABLE 10

| | Surface No. | | | | | |
|---|---|---|---|---|---|---|
| | S5 | S6 | S10 | S11 | S15 | S16 |
| k | −2.239E+00 | −3.940E+00 | 1.461E+01 | −4.151E−02 | −8.042E+00 | 9.900E+01 |
| A | −2.757E−01 | −1.297E−01 | −1.089E−01 | −1.167E−01 | −6.332E−01 | −8.184E−01 |
| B | 3.302E−02 | 2.586E−02 | −1.679E−02 | −2.118E−02 | −6.182E−02 | −3.722E−02 |
| C | −2.058E−03 | −2.371E−03 | −1.955E−03 | −1.808E−03 | −7.685E−03 | 7.518E−04 |
| D | 2.627E−04 | 3.720E−04 | −4.136E−04 | −2.542E−04 | −1.188E−03 | −2.752E−04 |
| E | 1.997E−05 | −1.002E−04 | −8.182E−06 | 0 | −1.068E−04 | 1.746E−04 |
| F | 0 | 3.559E−05 | −2.432E−06 | 0 | 0 | 0 |
| G | 0 | −1.244E−05 | 2.161E−05 | 0 | 0 | 0 |

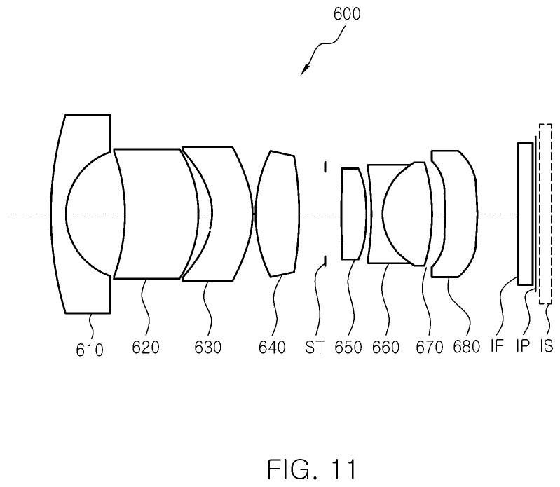

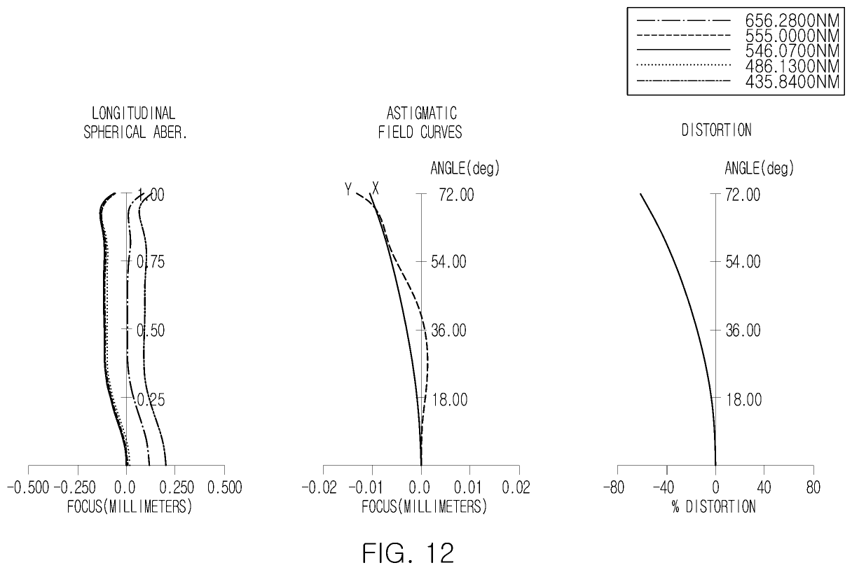

FIG. 11 is a configuration diagram of an imaging lens system according to a sixth embodiment of the present disclosure. FIG. 12 illustrates aberration curves of the imaging lens system illustrated in FIG. 11.

Referring to FIG. 11, an imaging lens system 600 may include a first lens 610, a second lens 620, a third lens 630, a fourth lens 640, a fifth lens 650, a sixth lens 660, a seventh lens 670, and an eighth lens 680.

The first lens 610 may have a negative refractive power, and may have a convex object-side surface and a concave image-side surface. The second lens 620 may have a positive refractive power, and may have a concave object-side surface and a convex image-side surface. The third lens 630 may have a negative refractive power, and may have a concave object-side surface and a convex image-side surface. The fourth lens 640 may have a positive refractive power, and may have a convex object-side surface and a convex image-side surface. The fifth lens 650 may have a positive refractive power, and may have a convex object-side surface and a convex image-side surface. The sixth lens 660 may have a negative refractive power, and may have a concave object-side surface and a concave image-side surface. The seventh lens 670 may have a positive refractive power, and may have a convex object-side surface and a convex image-side surface. The eighth lens 680 may have a positive refractive power, and may have a concave object-side surface and a convex image-side surface.

The imaging lens system 600 may further include a stop ST, a filter IF, and an imaging plane IP. The stop ST may be disposed between the fourth lens 640 and the fifth lens 650. The imaging plane IP may be formed on an image sensor IS, and the filter IF may be disposed between the eighth lens 680 and the imaging plane IP.

Tables 11 and 12 below illustrate lens characteristics and aspherical values of the imaging lens system 600.

TABLE 11

| Sur- | | | | | Refrac- | |
|---|---|---|---|---|---|---|
| face | | Radius of | Thickness/ | Effective | tive | Abbe |
| No. | Component | Curvature | Distance | Radius | Index | No. |
| S1 | 1st Lens | 24.3451 | 0.9299 | 6.686 | 1.883 | 40.8 |
| S2 | | 4.5976 | 3.6803 | 4.213 | | |
| S3 | 2nd Lens | −12.8125 | 4.5000 | 4.157 | 1.834 | 42.7 |
| S4 | | −8.8163 | 0.8723 | 4.368 | | |
| S5 | 3rd Lens | −4.8986 | 2.5000 | 4.283 | 1.536 | 56.0 |
| S6 | | −7.1627 | 0.2000 | 4.509 | | |
| S7 | 4th Lens | 10.3279 | 2.6442 | 4.248 | 1.729 | 54.6 |
| S8 | | −29.0236 | 1.6761 | 3.915 | | |
| S9 | Stop | Infinity | 0.9739 | 2.869 | | |
| S10 | 5th Lens | 31.7317 | 1.5456 | 2.934 | 1.535 | 56.0 |
| S11 | | −12.5224 | 0.3000 | 3.052 | | |
| S12 | 6th Lens | −24.0207 | 0.7000 | 3.058 | 1.684 | 26.8 |
| S13 | 7th Lens | 4.0374 | 3.0504 | 3.275 | 1.592 | 68.6 |
| S14 | | −12.8399 | 0.8164 | 3.459 | | |
| S15 | 8th Lens | −49.5890 | 1.9976 | 3.544 | 1.536 | 56.0 |
| S16 | | −44.5287 | 2.5133 | 4.250 | | |
| S17 | Filter | Infinity | 0.9000 | 4.692 | 1.516 | 64.1 |
| S18 | | Infinity | 0.2078 | 4.764 | | |
| S19 | Imaging | Infinity | −0.0097 | 4.792 | | |
| | Plane | | | | | |

TABLE 12

| | Surface No. | | | | | |
|---|---|---|---|---|---|---|
| | S5 | S6 | S10 | S11 | S15 | S16 |
| k | −2.217E+00 | −3.771E+00 | 2.524E+01 | −4.791E−01 | −6.007E+01 | 8.667E+01 |
| A | −2.967E−01 | −1.480E−01 | −1.033E−01 | −1.047E−01 | −6.106E−01 | −8.814E−01 |
| B | 3.800E−02 | 2.887E−02 | −1.562E−02 | −1.906E−02 | −6.114E−02 | −4.293E−02 |
| C | −2.369E−03 | −2.528E−03 | −1.741E−03 | −1.582E−03 | −7.291E−03 | 5.949E−04 |
| D | 3.539E−04 | 2.884E−04 | −3.560E−04 | −2.379E−04 | −9.597E−04 | −6.490E−04 |
| E | −2.145E−05 | −7.223E−05 | 3.069E−07 | 0 | −5.038E−05 | −7.005E−05 |
| F | 0 | −7.974E−06 | −8.804E−07 | 0 | 0.000E+00 | 0 |
| G | 0 | 9.521E−06 | 2.693E−05 | 0 | 0 | 0 |

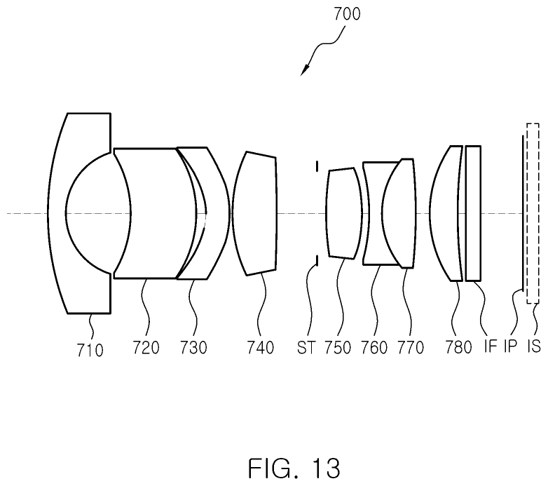

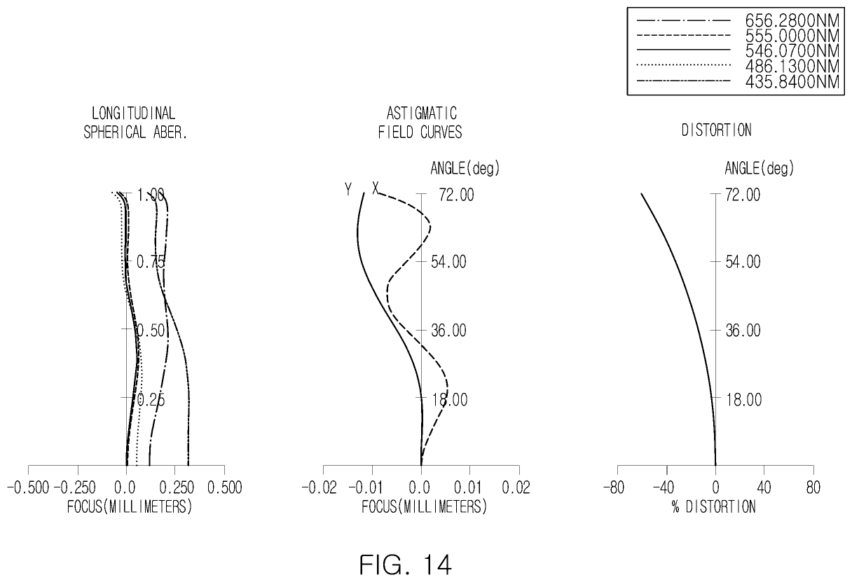

FIG. 13 is a configuration diagram of an imaging lens system according to a seventh embodiment of the present disclosure. FIG. 14 illustrates aberration curves of the imaging lens system illustrated in FIG. 13.

Referring to FIG. 13, an imaging lens system 700 may include a first lens 710, a second lens 720, a third lens 730, a fourth lens 740, a fifth lens 750, a sixth lens 760, a seventh lens, and an eighth lens 780.

The first lens 710 may have a negative refractive power, and may have a convex object-side surface and a concave image-side surface. The second lens 720 may have a positive refractive power, and may have a concave object-side surface and a convex image-side surface. The third lens 730 may have a negative refractive power, and may have a concave object-side surface and a convex image-side surface. The fourth lens 740 may have a positive refractive power, and may have a convex object-side surface and a convex image-side surface. The fifth lens 750 may have a positive refractive power, and may have a convex object-side surface and a convex image-side surface. The sixth lens 760 may have a negative refractive power, and may have a concave object-side surface and a concave image-side surface. The seventh lens 770 may have a positive refractive power, and may have a convex object-side surface and a convex image-side surface. The eighth lens 780 may have a positive refractive power, and may have a convex object-side surface and a concave image-side surface.

The imaging lens system 700 may further include a stop ST, a filter IF, and an imaging plane IP. The stop ST may be disposed between the fourth lens 740 and the fifth lens 750. The imaging plane IP may be formed on an image sensor IS, and the filter IF may be disposed between the eighth lens 780 and the imaging plane IP.

Tables 13 and 14 below illustrate lens characteristics and aspherical values of the imaging lens system 700.

TABLE 13

| Sur- | | | | | Refrac- | |
|---|---|---|---|---|---|---|
| face | | Radius of | Thickness/ | Effective | tive | Abbe |
| No. | Component | Curvature | Distance | Radius | Index | No. |
| S1 | 1st Lens | 19.4635 | 1.1327 | 6.856 | 1.883 | 40.8 |
| S2 | | 4.4466 | 4.0983 | 4.140 | | |
| S3 | 2nd Lens | −8.3073 | 4.1436 | 4.063 | 1.834 | 42.7 |
| S4 | | −8.0924 | 0.5935 | 4.450 | | |
| S5 | 3rd Lens | −5.0701 | 1.5006 | 4.383 | 1.536 | 56.0 |
| S6 | | −6.2219 | 0.2129 | 4.518 | | |
| S7 | 4th Lens | 10.8578 | 2.7735 | 4.201 | 1.729 | 54.6 |
| S8 | | −70.1464 | 2.5244 | 3.822 | | |
| S9 | Stop | Infinity | 0.6000 | 2.794 | | |
| S10 | 5th Lens | 28.0098 | 2.2405 | 2.904 | 1.535 | 56.0 |
| S11 | | −8.3303 | 0.4555 | 3.101 | | |
| S12 | 6th Lens | −14.3969 | 0.8360 | 3.113 | 1.656 | 21.2 |
| S13 | 7th Lens | 6.1913 | 2.1154 | 3.482 | 1.536 | 56.0 |
| S14 | | −33.4221 | 0.8758 | 3.704 | | |
| S15 | 8th Lens | 8.6328 | 1.7666 | 4.574 | 1.536 | 56.0 |
| S16 | | 33.0856 | 0.5143 | 4.567 | | |
| S17 | Filter | Infinity | 0.9000 | 4.563 | 1.516 | 64.1 |
| S18 | | Infinity | 2.7167 | 4.598 | | |
| S19 | Imaging | Infinity | 0.0000 | 4.772 | | |
| | Plane | | | | | |

TABLE 14

| | Surface No. | | | | | |
|---|---|---|---|---|---|---|
| | S5 | S6 | S10 | S11 | S12 | S14 |
| k | −2.603E+00 | −4.489E+00 | 3.222E+01 | −1.942E+01 | 1.058E+01 | −3.785E+01 |
| A | −2.751E−01 | −2.480E−01 | 2.007E−02 | −8.888E−02 | 7.513E−02 | 3.232E−02 |
| B | 2.986E−02 | 4.032E−02 | −1.101E−02 | −3.630E−02 | −3.807E−02 | −1.256E−03 |
| C | −5.057E−03 | −7.651E−03 | −1.168E−03 | 1.454E−04 | 4.783E−03 | 3.722E−03 |
| D | 1.694E−04 | 7.026E−04 | −8.446E−05 | 3.358E−04 | 7.755E−05 | −1.805E−04 |
| E | −4.705E−05 | −2.493E−04 | 3.997E−06 | 0 | 1.915E−04 | 2.306E−04 |
| F | 0 | 5.276E−05 | 8.086E−06 | 0 | 4.695E−05 | −5.261E−05 |
| G | 0 | 1.231E−05 | 1.067E−05 | 0 | 4.843E−06 | 6.586E−05 |

Tables 15 to 17 below illustrate optical characteristic values and conditional expression values of the imaging lens systems 100 to 700 according to the first to seventh embodiments.

TABLE 15

| | 1st | 2nd | 3rd | 4th | 5th | 6th | 7th |
|---|---|---|---|---|---|---|---|
| Value | Emb. | Emb. | Emb. | Emb. | Emb. | Emb. | Emb. |
| f | 3.9490 | 3.9490 | 3.9818 | 3.9600 | 3.9730 | 3.9758 | 3.9645 |
| f1 | −6.7080 | −6.8388 | −6.9435 | −6.4686 | −6.5950 | −6.5640 | −6.7662 |
| f2 | 18.5717 | 18.3155 | 17.9206 | 21.9868 | 23.4103 | 22.4149 | 38.3981 |
| f3 | −14.2005 | −13.0339 | −12.6523 | −28.8291 | −43.0082 | −47.0355 | −93.6848 |
| f4 | 10.6764 | 11.0550 | 10.7251 | 10.7060 | 10.7441 | 10.7536 | 13.0866 |
| f5 | 13.1596 | 12.7934 | 13.5385 | 17.2114 | 16.8386 | 16.9900 | 12.2649 |
| f6 | −6.2269 | −6.4067 | −6.9044 | −5.8633 | −5.0478 | −5.0025 | −6.4953 |
| f7 | 6.6063 | 6.5090 | 6.9340 | 6.2279 | 5.5669 | 5.5623 | 9.9307 |
| f8 | 76.1580 | 94.2113 | 60.1079 | 201.1218 | 937.3519 | 715.5373 | 21.2562 |
| TTL | 30.0000 | 30.0000 | 30.0000 | 30.0001 | 29.9975 | 29.9981 | 30.0002 |
| f number | 1.6000 | 1.6000 | 1.6000 | 1.6000 | 1.6000 | 1.6000 | 1.6000 |
| IMGHT | 9.2520 | 9.2520 | 9.2520 | 9.2520 | 9.2520 | 9.2520 | 9.2520 |
| FOV | 138.4000 | 138.4000 | 138.4000 | 138.4000 | 138.4000 | 138.4000 | 138.4000 |
| L4DnT | 1.7900 | 1.7900 | 1.7900 | 3.2900 | 1.7900 | 1.7900 | 2.4200 |
| L4CTE | 5.7000 | 5.7000 | 5.7000 | 5.7000 | 5.7000 | 5.7000 | 5.7000 |

TABLE 16

| Cond. Exp. | 1st Emb. | 2nd Emb. | 3rd Emb. | 4th Emb. | 5th Emb. | 6th Emb. | 7th Emb. |
|---|---|---|---|---|---|---|---|
| f/f4 | 0.3699 | 0.3572 | 0.3713 | 0.3699 | 0.3698 | 0.3697 | 0.3029 |
| f1/f4 | −0.6283 | −0.6186 | −0.6474 | −0.6042 | −0.6138 | −0.6104 | −0.5170 |
| f2/f4 | 1.7395 | 1.6568 | 1.6709 | 2.0537 | 2.1789 | 2.0844 | 2.9342 |
| f3/f4 | −1.3301 | −1.1790 | −1.1797 | −2.6928 | −4.0030 | −4.3739 | −7.1588 |
| f5/f4 | 1.2326 | 1.1573 | 1.2623 | 1.6076 | 1.5672 | 1.5799 | 0.9372 |
| f6/f4 | −0.5832 | −0.5795 | −0.6438 | −0.5477 | −0.4698 | −0.4652 | −0.4963 |
| f7/f4 | 0.6188 | 0.5888 | 0.6465 | 0.5817 | 0.5181 | 0.5172 | 0.7588 |
| f8/f4 | 7.1333 | 8.5221 | 5.6044 | 18.7860 | 87.2438 | 66.5390 | 1.6243 |
| TTL/f4 | 2.8099 | 2.7137 | 2.7972 | 2.8022 | 2.7920 | 2.7896 | 2.2924 |
| R1/f4 | 2.0145 | 1.9542 | 2.0756 | 2.1741 | 2.2404 | 2.2639 | 1.4873 |
| R3/f4 | −1.2066 | −1.2022 | −1.3385 | −1.1462 | −1.1954 | −1.1915 | −0.6348 |

TABLE 17

| Cond. | 1st | 2nd | 3rd | 4th | 5th | 6th | 7th |
|---|---|---|---|---|---|---|---|
| Exp. | Emb. | Emb. | Emb. | Emb. | Emb. | Emb. | Emb. |
| f6/f | −1.5768 | −1.6224 | −1.7340 | −1.4806 | −1.2705 | −1.2582 | −1.6384 |
| f7/f | 1.6729 | 1.6483 | 1.7414 | 1.5727 | 1.4012 | 1.3990 | 2.5049 |
| f6/f7 | −0.9426 | −0.9843 | −0.9957 | −0.9415 | −0.9068 | −0.8994 | −0.6541 |
| (R1 + R3)/R4 | −0.9885 | −0.9457 | −0.8791 | −1.3033 | −1.2528 | −1.3081 | −1.3786 |
| (R5 + R6)/R3 | 0.9948 | 0.9726 | 1.0689 | 0.9733 | 0.9486 | 0.9414 | 1.3593 |
| (R4 + R5)/R7 | −1.0780 | −1.0468 | −1.1150 | −1.0904 | −1.3308 | −1.3279 | −1.2123 |

The present disclosure describes an imaging lens system having constant optical characteristics (focal length) in a wide temperature range from a high temperature environment of 80° C. to a low temperature environment of −40° C.

While this disclosure includes specific examples, it will be apparent after an understanding of the disclosure of this application that various changes in form and details may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An imaging lens system comprising:
a first lens, a second lens, a third lens, a fourth lens, a fifth lens, a sixth lens, a seventh lens, and an eighth lens sequentially disposed in ascending numerical order along an optical axis of the imaging lens system from an object side of the imaging lens system toward an imaging plane of the imaging lens system,
wherein the second lens has a positive refractive power,
the third lens has a convex image-side surface in a paraxial region thereof, and
the imaging lens system satisfies the following conditional expression:
$$0.3 < f / f 4 < 0.4$$
where f is a focal length of the imaging lens system, and f4 is a focal length of the fourth lens.

2. The imaging lens system of claim 1, wherein the first lens has a convex object-side surface in a paraxial region thereof.

3. The imaging lens system of claim 1, wherein the second lens has a concave object-side surface in a paraxial region thereof.

4. The imaging lens system of claim 1, wherein the fourth lens has a convex object-side surface in a paraxial region thereof.

5. The imaging lens system of claim 1, wherein the fifth lens has a convex object-side surface in a paraxial region thereof.

6. The imaging lens system of claim 1, wherein the sixth lens has a convex object-side surface in a paraxial region thereof.

7. The imaging lens system of claim 1, wherein the sixth lens has a concave object-side surface in a paraxial region thereof.

8. The imaging lens system of claim 1, wherein the seventh lens has a convex object-side surface in a paraxial region thereof.

9. The imaging lens system of claim 1, wherein the eighth lens has a convex object-side surface in a paraxial region thereof.

10. An imaging lens system comprising:
a first lens, a second lens, a third lens, a fourth lens, a fifth lens, a sixth lens, a seventh lens, and an eighth lens sequentially disposed in ascending numerical order along an optical axis of the imaging lens system from an object side of the imaging lens system toward an imaging plane of the imaging lens system,
wherein the second lens has a positive refractive power, and
the imaging lens system satisfies the following conditional expression:
$$2. < TTL / f 4 < 3.$$
where TTL is a distance along the optical axis from an object-side surface of the first lens to the imaging plane, and f4 is a focal length of the fourth lens.

11. The imaging lens system of claim 10, wherein the object-side surface of the first lens is convex in a paraxial region thereof.

12. The imaging lens system of claim 10, wherein the second lens has a concave object-side surface in a paraxial region thereof.

13. The imaging lens system of claim 10, wherein the fourth lens has a convex object-side surface in a paraxial region thereof.

14. The imaging lens system of claim 10, wherein the fifth lens has a convex object-side surface in a paraxial region thereof.

15. The imaging lens system of claim 10, wherein the sixth lens has a convex object-side surface in a paraxial region thereof.

16. The imaging lens system of claim 10, wherein the sixth lens has a concave object-side surface in a paraxial region thereof.

17. The imaging lens system of claim 10, wherein the seventh lens has a convex object-side surface in a paraxial region thereof.

18. The imaging lens system of claim 10, wherein the eighth lens has a convex object-side surface in a paraxial region thereof.

19. An imaging lens system comprising:
a first lens, a second lens, a third lens, a fourth lens, a fifth lens, a sixth lens, a seventh lens, and an eighth lens sequentially disposed in ascending numerical order along an optical axis of the imaging lens system from an object side of the imaging lens system toward an imaging plane of the imaging lens system,
wherein the imaging lens system satisfies the following conditional expression:
$$- 1.6 < R 3 / f 4 < - 0.4$$
where R3 is a radius of curvature of an object-side surface of the second lens at the optical axis, and f4 is a focal length of the fourth lens.

20. The imaging lens system of claim 19, wherein the second lens has a positive refractive power.
